(19) United States
(12) Patent Application Publication
(10) Pub. No.: US 2016/0196578 A1
(43) Pub. Date: Jul. 7, 2016

(54) SYSTEM AND METHOD FOR RECOMMENDING PRODUCT PURCHASED PERIODICALLY, APPARATUS AND NON-TRANSITORY COMPUTER READABLE STORAGE MEDIUM HAVING COMPUTER PROGRAM RECORDED THEREON

(71) Applicant: SK PLANET CO., LTD., Seongnam-si (KR)

(72) Inventor: Jong Won WOO, Incheon (KR)

(21) Appl. No.: 14/958,616

(22) Filed: Dec. 3, 2015

(30) Foreign Application Priority Data
Jan. 5, 2015 (KR) 10-2015-0000586

(51) Int. Cl. G06Q 30/02

(52) U.S. Cl. CPC G06Q 30/0254; G06Q 30/0255

(57) ABSTRACT

The present invention relates to a system, a method, an apparatus for recommending a product purchased periodically which determine a product purchased periodically by collecting electronic receipts for products purchased by a user and recommend an optimal product based on a purchase pattern for the product purchased periodically. According to the present invention, an optimal product corresponding to a purchase pattern of a user is recommended at the time when a user purchases a product purchased periodically by transmitting information on an optimal product for each item periodically purchased by the user every purchase period depending on the purchase pattern to purchase and be delivered with a periodically recommended product, thereby enhancing shopping efficiency for the purchase of the item purchased periodically and increasing a selection width of the user by recommending various products every purchase period corresponding to the item purchased periodically.

### CROSS-REFERENCE TO RELATED APPLICATION

This application claims the benefit of Korean Application No. 10-2015-0000586 filed on Jan. 5, 2015 with the Korean Intellectual Property Office, the disclosure of which is incorporated herein by reference.

### BACKGROUND OF THE INVENTION

1. Field of the Invention

The present invention relates to a system and a method for recommending a product purchased periodically, an apparatus and a non-transitory computer readable storage medium having a computer program recorded thereon, and more particularly, to a system and a method for recommending a product purchased periodically which determine a product purchased periodically by collecting electronic receipts for products purchased by a user and recommend an optimal product based on a purchase pattern for the product purchased periodically, an apparatus and a non-transitory computer readable storage medium having a computer program recorded thereon.

2. Description of the Related Art

With the development of a commerce market using a mobile, a user conveniently settles various items required for a daily life by visiting various online shopping sites by using a terminal thereof and receives a service to be directly delivered the settled items to a residence.

However, there is inconvenience that the user should directly search and thereafter, purchase an optimal product every time even with respect to products purchased periodically, such as milk, egg, toilet paper, and the like. Therefore, there is a problem that the user uses a service to periodically support a delivery in the case of the product such as the milk, but should request a delivery service only for a product of a specific company among various products related with the milk to restrict a selection right of the user.

### SUMMARY OF THE INVENTION

An object of the present invention is to conveniently purchase a product purchased periodically by collecting electronic receipts for products purchased by a user and periodically selecting an optimal product for each product item based on a purchase pattern for each product item purchased periodically based on the collected electronic receipts and recommending the selected product to the user.

According to an aspect of the present invention, an apparatus for providing a service for recommending a product purchased periodically, includes: a purchase information collecting unit collecting product purchase information from a settlement service providing apparatus generating the product purchase information depending on product purchase of a user apparatus and matching the product purchase information with an item of a product corresponding to the product purchase information and accumulating and storing the corresponding product purchase information matching the item; a periodic purchase item collecting unit determining a purchase period for each item based on the accumulated product purchase information to select one or more periodic purchase items of which purchase frequencies are equal to or more than a predetermined reference value; a purchase pattern calculating unit calculating a purchase pattern for each periodic purchase item based on the accumulated product purchase information to correspond to the periodic purchase item; and a periodic purchase product recommending unit selecting a recommended product based on the purchase pattern every purchase period depending on the purchase pattern for each periodic purchase item and transmitting generated recommended product information to the user apparatus.

Preferably, the product purchase information may be electronic receipt information.

Preferably, the periodic purchase item collecting unit may calculate the purchase frequency during a predetermined past period from the present.

Preferably, the purchase pattern calculating unit may calculate the purchase pattern including at least one of an average purchase quantity, the average number of purchase times, an average price, and a preferred manufacturer and an average purchase period for each item based on the accumulated product purchase information.

Preferably, the periodic purchase product recommending unit may select the recommended product according to at least one of the average purchase quantity, the average number of purchase times, the average price, and the preferred manufacturer and transmit the recommended product information according to the average purchase period.

Preferably, the periodic purchase product recommending unit may transmit a link for settling the recommended product, which is included in the recommended product information.

Preferably, the settlement service providing apparatus may be an online shopping mall server or a POS device.

Preferably, the periodic purchase product recommending unit may collect recommended product information regarding a plurality of items of which the average purchase periods coincide with each other to generate recommended list information and transmit the generated recommended list information to the user apparatus.

According to another aspect of the present invention, a user apparatus for recommending a product purchased periodically, includes: a purchase information collecting unit receiving product purchase information depending on product purchase of a user from an external server and accumulating and storing the received product purchase information to correspond to an item to which a product corresponding to the product purchase information belongs; a periodic purchase item collecting unit determining a purchase period for each item based on the accumulated product purchase information to select one or more periodic purchase items of which purchase frequencies are equal to or more than a predetermined reference value; a purchase pattern calculating unit calculating a purchase pattern for each periodic purchase item based on the accumulated product purchase information to correspond to the periodic purchase item; and a periodic purchase product recommending unit selecting a recommended product by accessing an online shopping mall server based on the purchase pattern every purchase period depending on the purchase pattern for each periodic purchase item and providing recommended product information regarding the selected recommended product.

According to yet another aspect of the present invention, a method for providing a service for recommending a product purchased periodically, includes: collecting, by an apparatus for providing a service for recommending a product purchased periodically, which communicates with a user apparatus, product purchase information from a settlement service providing apparatus generating the product purchase information depending on product purchase of the user apparatus and accumulating and storing the collected product purchase information to correspond to an item to which a product corresponding to the product purchase information belongs; determining, by the apparatus for providing a service for recommending a product purchased periodically, a purchase frequency for each item based on the accumulated product purchase information to select one or more periodic purchase items of which the purchase frequencies are equal to or more than a predetermined reference value; calculating, by the apparatus for providing a service for recommending a product purchased periodically, a purchase pattern for each periodic purchase item based on the accumulated product purchase information to correspond to the periodic purchase item; and selecting, by the apparatus for providing a service for recommending a product purchased periodically, a recommended product based on the purchase pattern every purchase period depending on the purchase pattern for each periodic purchase item and transmitting generated recommended product information to the user apparatus.

According to still another aspect of the present invention, a computer program executing the method for providing a service for recommending a product purchased periodically may be stored in a non-transitory computer readable storage medium having a computer program recorded thereon according to the aforementioned embodiments.

According to still yet another aspect of the present invention, a system for providing a service for recommending a product purchased periodically, includes: a settlement service providing apparatus generating and providing product purchase information depending on product purchase of a user apparatus; and an apparatus for providing a service for recommending a product purchased periodically, collecting the product purchase information to correspond to the user apparatus from the settlement service providing apparatus and accumulating and storing the corresponding product purchase information to correspond to an item to which a product corresponding to the product purchase information belongs, determining a purchase period for each item based on the accumulated product purchase information to select one or more periodic purchase items of which purchase frequencies are equal to or more than a predetermined reference value, calculating a purchase pattern for each periodic purchase item based on the accumulated product purchase information to correspond to the periodic purchase item, and selecting a recommended product based on the purchase pattern every purchase period depending on the purchase pattern for each periodic purchase item and transmitting generated recommended product information to the user apparatus.

According to the present invention, an optimal product corresponding to a purchase pattern of a user is recommended at the time when a user is requested to conveniently purchase a product purchased periodically by transmitting information on an optimal product for each item periodically purchased by the user every purchase period depending on the purchase pattern to purchase and be delivered with a periodically recommended product, thereby enhancing user efficiency and shopping efficiency for the purchase of the item purchased periodically and increasing a selection width of the user by recommending various products every purchase period corresponding to the item purchased periodically.

Further, a product periodically purchased by a user can be supported to be periodically purchased and delivered according to a purchase pattern of the user to support increasing convenience of purchase and stock management of a seller and extending sales of the seller.

### BRIEF DESCRIPTION OF THE DRAWINGS

FIG. 1 is a configuration diagram of a system for providing a service for recommending a product purchased periodically according to an embodiment of the present invention.

FIG. 2 is a detailed configuration diagram of an apparatus for providing a service for recommending a product purchased periodically according to the embodiment of the present invention.

FIG. 3 is a configuration diagram of collection of product purchase information of the apparatus for providing a service for recommending a product purchased periodically according to the embodiment of the present invention.

FIG. 4 is a configuration diagram of selection of an item purchased periodically and calculation of a purchase pattern of the apparatus for providing a service for recommending a product purchased periodically according to the embodiment of the present invention.

FIGS. 5 and 6 are configuration diagrams of recommendation of a product for each item purchased periodically of the apparatus for providing a service for recommending a product purchased periodically according to the embodiment of the present invention.

FIG. 7 is a detailed configuration diagram of a user apparatus for recommending a product purchased periodically according to the embodiment of the present invention.

FIG. 8 is a flowchart of a method for providing a service for recommending a product purchased periodically according to an embodiment of the present invention.

### DETAILED DESCRIPTION OF THE PREFERRED EMBODIMENTS

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not included or additional components or steps may be further included. In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

Hereinafter, detailed embodiments of the present invention will be described with reference to the accompanying drawings.

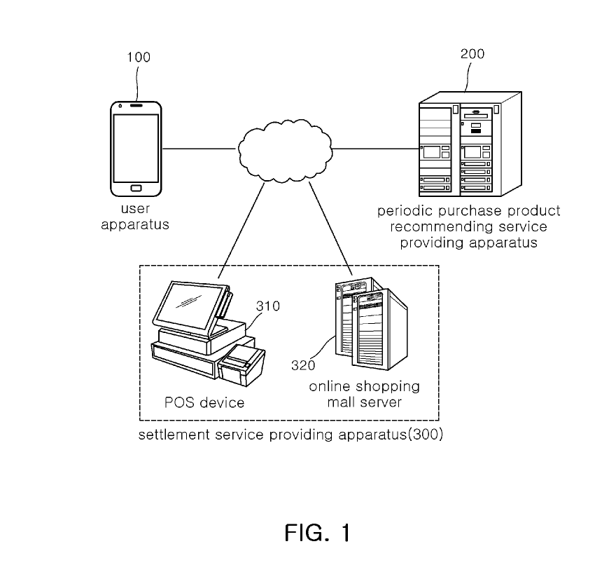

FIG. 1 is a configuration diagram of a system for providing a service for recommending a product purchased periodically according to an embodiment of the present invention and as illustrated in FIG. 1, the system may include a settlement service providing apparatus 300 generating product purchase information regarding a product purchased by a user, a user apparatus 100 of the user who purchases the product through the settlement service providing apparatus 300, and a periodic purchase product recommending service providing apparatus 200 connected with the settlement service providing apparatus 300 through a communication network.

In this case, the communication network may adopt various communication schemes which are widely used and the user apparatus 100 may include various terminals such as a tablet PC including a communication function, a laptop, a smart phone, a portable terminal, a mobile terminal, a personal digital assistant (PDA), a portable multimedia player (PMP) terminal, a personal computer, and a wearable personal station (WPS) and the periodic purchase product recommending service providing apparatus 200 may be constituted by a server.

Further, the settlement service providing apparatus 300 may include a point of sale (POS) device 310 or an online shopping mall server 320.

The periodic purchase product recommending service providing apparatus 200 collects the product purchase information from the settlement service providing apparatus 300 to determine a periodic purchase item of the user and a purchase pattern for each periodic purchase item and searches a recommended product based on the purchase pattern for each purchase period depending on the purchase pattern corresponding to each periodic purchase item to transmit generated recommended product information to the user apparatus 100.

As a result, the user apparatus 100 accesses the online shopping mall server 320 based on link information regarding the recommended product included in the recommended product information to purchase and be delivered with the corresponding recommended product.

As such, the periodic purchase product recommending service providing apparatus 200 is provided to transmit information on an optimal product for each item periodically purchased by the user every purchase period depending on the purchase pattern of the user to allow the user to conveniently purchase and be delivered with the periodic purchase item at the time when the purchase of the periodic purchase item is requested.

A detailed configuration of the periodic purchase product recommending service providing apparatus 200 will be described based on the above configuration with reference to a drawing to be described below.

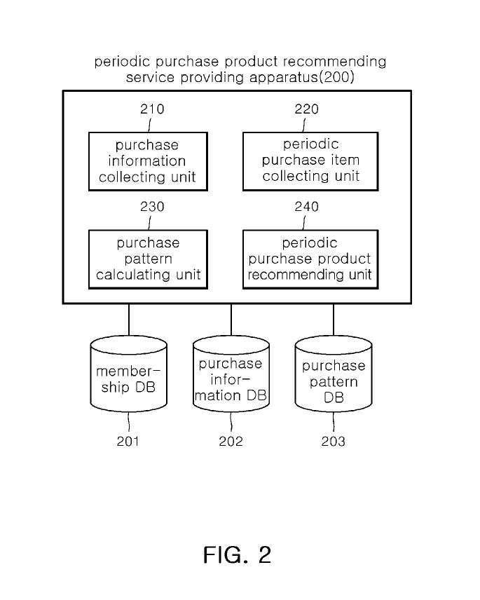

FIG. 2 is a detailed configuration diagram of an apparatus 200 for providing a service for recommending a product purchased periodically and as illustrated in FIG. 2, the apparatus 200 may include a purchase information collecting unit 210, a periodic purchase item collecting unit 220, a purchase pattern calculating unit 230, and a periodic purchase product recommending unit 240.

In this case, the periodic purchase product recommending service providing apparatus 200 may be constituted by an independent server or the online shopping mall server 320.

When each component of the periodic purchase product recommending service providing apparatus 200 is described in detail, first, in the case of purchasing products through an online or offline shopping mall, the settlement service providing apparatus 300 including the online shopping mall server 320 or the POS device 310 disposed in an offline shopping mall generates the product purchase information according to settlement of the product purchased by the user.

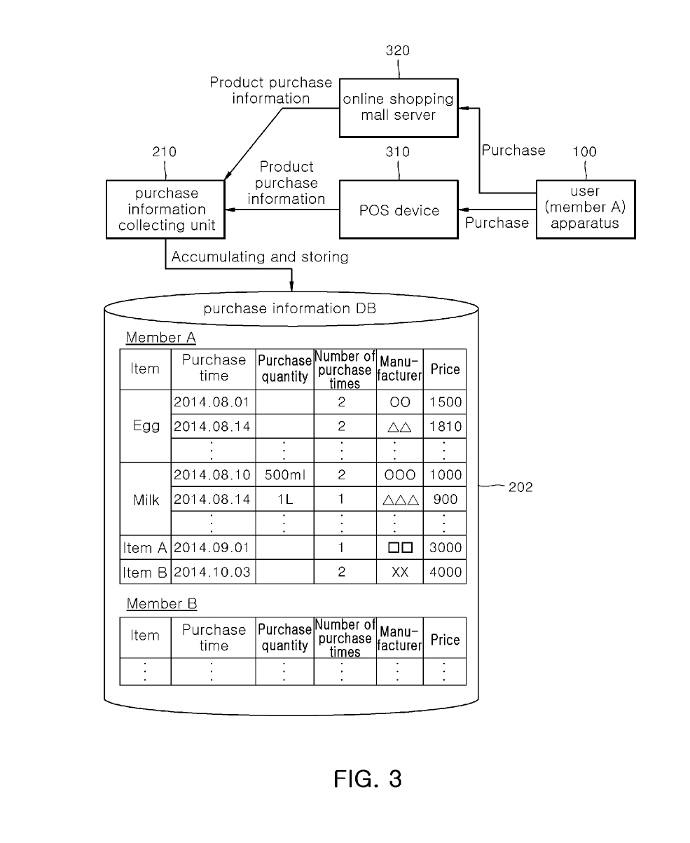

As a result, as illustrated in FIG. 3, the purchase information collecting unit 210 may collect the product purchase information depending on the product purchase by the user, which is continuously received from the settlement service providing apparatus 300 through the communication network and accumulate and store the product purchase information to correspond to membership information of the user in a purchase information DB 202 by comparing user information included in the product purchase information and the membership information stored in the membership DB 201.

In this case, the product purchase information may include electronic receipt information, card transaction history information, and the like.

Further, the user information and the membership information may include various settlement means related information including a credit card, a point card, and the like in addition user identification information including an ID, a name, a phone number, and the like of the user.

As a result, the purchase information collecting unit 210 may determine the item of the product corresponding to the product purchase information at the time of storing the product purchase information to correspond to the membership information in the purchase information DB 202 and accumulate and store the product purchase information by distinguishing the product purchase information for each item.

As one example, as illustrated in FIG. 3, the purchase information collecting unit 210 may accumulate and store product purchase information regarding a plurality of eggs related with eggs purchased at different times by matching the product purchase information with egg items and in this case, the purchase information collecting unit 210 may generate milk items by differentiating the items from the eggs with respect to a plurality of product purchase information related with the milk, which is generated according to milk purchase of the user and accumulate and store the milk related product purchase information in the purchase information DB 202 to correspond to the membership information of the user by matching the milk related product purchase information with the corresponding milk item.

Further, the product purchase information may include an item, a product name, a purchase time, a purchase quantity, the number of purchased products, a manufacturer, a price, an expiration date, and the like.

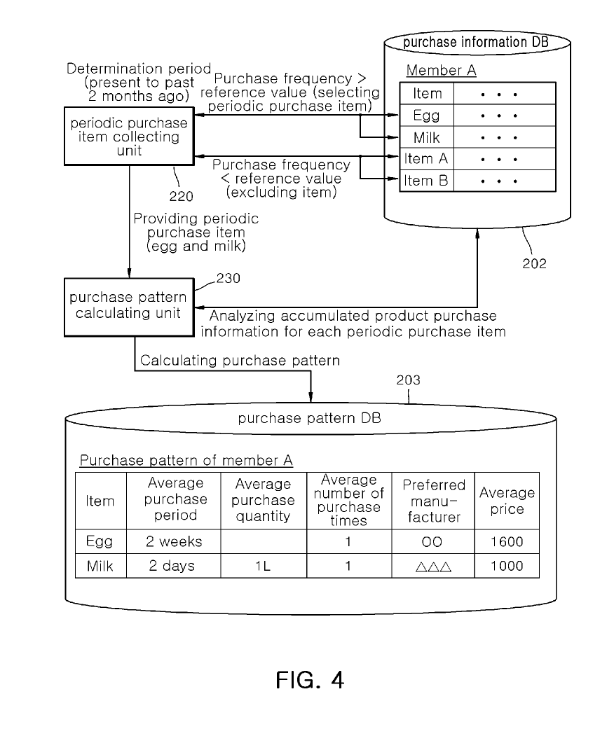

Meanwhile, as illustrated in FIG. 4, the periodic purchase item collecting unit 220 may calculate a purchase frequency for each item based on the product purchase information accumulated and stored for each item to correspond to the membership information of the user in the purchase information DB 202.

In this case, various calculation equations or algorithms may be applied to the calculation of the purchase frequency of the periodic purchase item collecting unit 220 and a reference period which is a calculation criterion for the calculation of the purchase frequency may be set in the periodic purchase item collecting unit 220 in advance.

As one example, the periodic purchase item collecting unit 220 may calculate the purchase frequency for each item for the product purchase information accumulated and stored during a predetermined past period from the present.

As a result, the periodic purchase item collecting unit 220 may select an item in which the purchase frequency is equal to or more than a predetermined reference value as the periodic purchase item and provide information on the periodic purchase item to the purchase pattern calculating unit 230.

In an illustrated example, since the purchase frequencies of the eggs and the milk are equal to or more than the reference value, the periodic purchase item collecting unit 220 may select the items for the eggs and the milk as the periodic purchase item and provide the selected items to the purchase pattern calculating unit 230.

Meanwhile, the purchase pattern calculating unit 230 may calculate the purchase pattern of the user for the periodic purchase item based on the product purchase information accumulated and stored in the purchase information DB 202 for each periodic purchase item with respect to each periodic purchase item.

As one example, the purchase pattern calculating unit 230 may calculate any one of an average value, a maximum value, and a minimum value for each parameter of the product purchase information accumulated and stored for each periodic purchase item as illustrated in FIG. 4, and as a result, the purchase pattern calculating unit 230 may calculate a purchase pattern including an average purchase period, an average purchase quantity, the average number of purchase times, a preferred manufacturer, an average price, and the like.

Further, the purchase pattern calculating unit 230 may match the purchase pattern information regarding the calculated purchase pattern for each periodic purchase item with membership information and store the purchase pattern information in the purchase pattern DB 203.

In the above configuration, the periodic purchase item collecting unit 220 and the purchase pattern calculating unit 230 calculate the periodic purchase item and the purchase pattern in real time or periodically to update the purchase pattern information stored in the purchase pattern DB 203, of course.

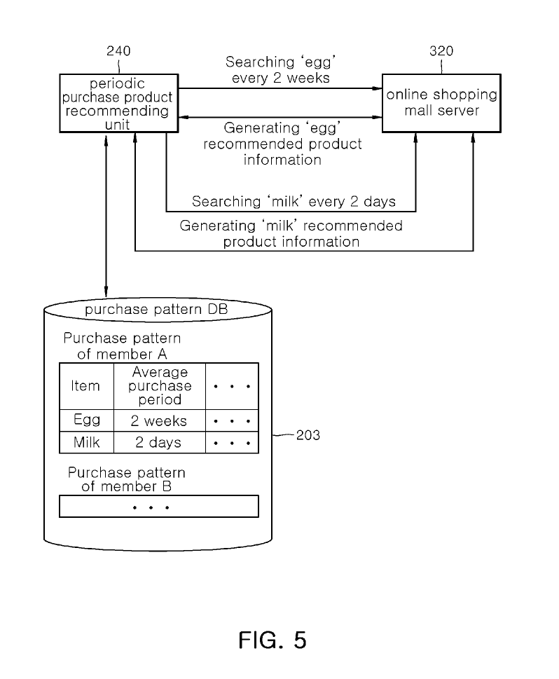

Meanwhile, as illustrated in FIG. 5, the periodic purchase product recommending unit 240 accesses the online shopping mall server 320 every average purchase period included in the purchase pattern information for each periodic purchase item based on the purchase pattern information corresponding to each periodic purchase item matched with the membership information of the user and stored in the purchase pattern DB 203 to select a recommended product corresponding to each periodic purchase item and transmit the corresponding recommended product to the user apparatus 100.

Further, the periodic purchase product recommending unit 240 may select an optimal recommended product based on the average purchase quantity, the average number of purchase times, the preferred manufacturer, the average price, and the like included in the purchase pattern information corresponding to the periodic purchase item at the time of selecting the recommended product corresponding to the periodic purchase item.

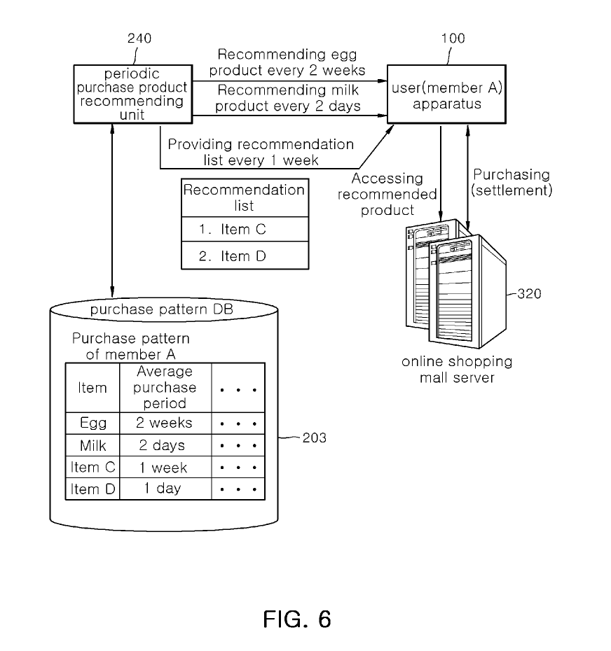

As one example, the periodic purchase product recommending unit 240 determines whether the periodic purchase item is generated in the purchase pattern DB 203 to verify the average purchase period of the purchase pattern information corresponding to the periodic purchase item at the time of generating the periodic purchase item. Accordingly, the periodic purchase product recommending unit 240 may generate the recommended product information by searching the recommended product in the online shopping mall server 320 based on the average purchase quantity, the average number of purchase times, the preferred manufacturer, the average price, and the like of the purchase pattern information every two weeks which is the average purchase period depending on the purchase pattern information when the period purchase item for the egg is generated in the purchase pattern DB 203 and transmit the corresponding recommended product information to the user apparatus 100 as illustrated in FIG. 6.

In this case, the periodic purchase product recommending unit 240 may search the recommended product in the online shopping mall server 320 every average purchase period of each periodic purchase item and transmit the searched recommended product information to the user apparatus 100 and when contents of the purchase pattern information are changed according to the update of the purchase pattern information, a product different from a product recommended during the existing purchase period may be recommended, of course, whenever each purchase period is reached.

Further, when the average purchase periods of different periodic purchase items coincide with each other, the periodic purchase product recommending unit 240 may generate list information acquired by integrating the recommended product information of the respective periodic purchase items of which the average purchase periods coincide with each other and transmit the generated list information to the user apparatus 100.

Moreover, the periodic purchase product recommending unit 240 may provide the plurality of recommended product information included in the recommended product information and the list information while the link information for integrated purchase and settlement is included in the recommended product information or the list information in the online shopping mall server 320.

As a result, as illustrated in FIG. 6, the user apparatus 100 that receives the recommended product information or the list information may conveniently integratedly settle the periodic purchase item through the corresponding link information and be delivered with the settled periodic purchase item.

In this case, the periodic purchase product recommending unit 240 may directly perform the settlement by interlocking with the online shopping mall server 320 and as one example, the periodic purchase product recommending unit 240 stores shopping basket information temporarily storing one or more products corresponding to the recommended product information or the list information in a separate settlement DB (not illustrated) and receives the recommended product information and the list information including the link information regarding the shopping basket information stored in the settlement DB to perform the settlement of the shopping basket information according to selection of the user apparatus 100 which accesses the periodic purchase product recommending unit 240 according to the corresponding link information and settle the product corresponding to the recommended product information or the list information and thereafter, deliver the settled product.

As such, according to the present invention, a product most suitable for the purchase pattern of the user is recommended to the user with respect to the corresponding periodic purchase item every average purchase period corresponding to each of different periodic purchase items to conveniently purchase the periodic purchase item at an appropriate purchase time.

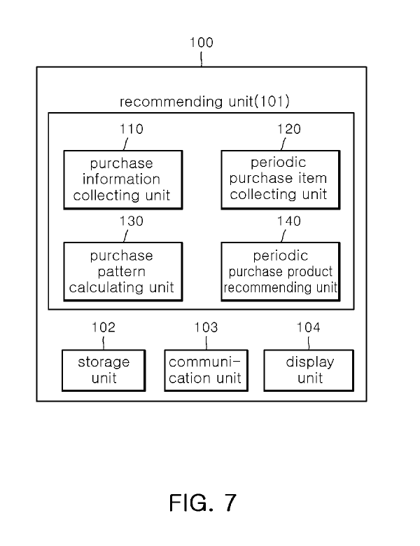

Meanwhile, the components of the periodic purchase product recommending service apparatus may be constituted in the user apparatus 100 and the constitution will be described in detail with reference to FIG. 7.

FIG. 7 is a detailed configuration diagram of a user apparatus 100 for recommending a product purchased periodically and as illustrated in FIG. 7, a recommending unit 101 including the purchase information collecting unit 110, the periodic purchase item collecting unit 120, the purchase pattern calculating unit 130, and the periodic purchase product recommending unit 140 may be constituted in the user apparatus 100 and the recommending unit 101 may be constituted in the user apparatus 100 in the form of an application.

First, the purchase information collecting unit 110 may receive the product purchase information depending on the product purchase of the user from an external server through a communication unit 103 constituted in the user apparatus 100 and accumulate and store the received product purchase information to correspond to the item to which the product corresponding to the product purchase information belongs in a storage unit 102 of the user apparatus 100. In this case, the external server may be constituted by the periodic purchase product recommending service providing apparatus 200.

Further, the periodic purchase item collecting unit 120 determines the purchase period for each item based on the product purchase information accumulated in the storage unit 102 to select one or more periodic purchase items of which the purchase frequencies are equal to or more than the predetermined reference value.

Moreover, the purchase pattern calculating unit 130 calculates the purchase pattern each periodic purchase item based on the product purchase information accumulated to correspond to the periodic purchase item selected by the periodic purchase item collecting unit 120 to store the purchase pattern information in the storage unit 102.

Thereafter, the periodic purchase product recommending unit 140 accesses the online shopping mall server 320 based on the purchase pattern every purchase period depending on the purchase pattern for each periodic purchase item to select the recommended product and output the recommended product information regarding the selected recommended product through a display. In this case, the periodic purchase product recommending unit 140 may output the recommended product information through the display unit 104 of the user apparatus 100 in the form of notification.

In addition to the components, each component constituted in the recommending unit 101 may have some components of the periodic purchase product recommending service providing apparatus 200, of course.

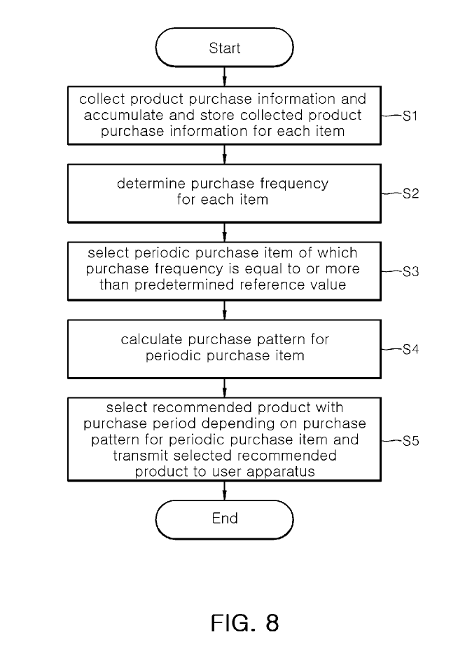

FIG. 8 is a flowchart of a method for providing a service for recommending a product purchased periodically according to an embodiment of the present invention and a periodic purchase product recommending service providing apparatus 200 which communicates with a user apparatus 100 may collect product purchase information from a settlement service providing apparatus 300 generating the product purchase information depending on product purchase of the user apparatus 100 and accumulate and store the collected product purchase information in a DB to correspond to an item to which a product corresponding to the product purchase information belongs.

Thereafter, the periodic purchase product recommending service providing apparatus 200 determines a purchase frequencies for each item based on the accumulated product purchase information (S2) to select one or more periodic purchase items of which the purchase frequencies are equal to or more than a predetermined reference value (S3).

Next, the periodic purchase product recommending service providing apparatus 200 may calculate a purchase pattern for each periodic purchase item based on the accumulated product purchase information to correspond to a periodic purchase item (S4).

Thereafter, the periodic purchase product recommending service providing apparatus 200 selects a recommended product based on the purchase pattern every purchase period depending on the purchase pattern for each periodic purchase item to transmit generated recommended product information to the user apparatus 100 (S5).

The method for providing a service for recommending a product purchased periodically according to the embodiment of the present invention may be prepared with a computer program, and codes and code segments configuring the computer program may easily deduced by a computer programmer in the art. Further, the corresponding computer program is stored in a non-transitory computer readable storage medium, and read and executed by the computer or the user apparatus, the apparatus for providing a service for recommending a product purchased periodically, and the like according to the embodiment of the present invention to implement the method for providing a service for recommending a product purchased periodically.

The non-transitory computer readable storage medium includes a magnetic storage medium, an optical storage medium, and a carrier wave medium. The computer program implementing the method for providing a service for recommending a product purchased periodically according to the embodiment of the present invention may be stored and installed in embedded memories of the user apparatus and the apparatus for providing a service for recommending a product purchased periodically. Alternatively, external memories such as a smart card storing and installing the computer program implementing the method for providing a service for recommending a product purchased periodically according to the embodiment of the present invention may be installed on the user apparatus and the apparatus for providing a service for recommending a product purchased periodically.

According to the present invention, information on an optimal product for each item periodically purchased by a user is transmitted every purchase period depending on a purchase pattern of the user to allow the user to conveniently purchase and be delivered with a periodic purchase item at the time when purchasing the periodic purchase item, thereby enhancing user efficiency and shopping efficiency, therefore, the present invention can be widely used in an online shopping mall service system a curating service system, and the like.

Hereinabove, preferred embodiments according to the present invention haven been illustrated and described. However, the present invention is not limited to the aforementioned embodiments and various modifications can be made by those skilled in the art without departing from the spirit of the present invention, which is accompanied in the appended claims.

What is claimed is:

1. An apparatus for providing a service for recommending a product purchased periodically, the apparatus comprising:
a purchase information collecting unit collecting product purchase information from a settlement service providing apparatus generating the product purchase information depending on product purchase of a user apparatus and matching the product purchase information with an item of a product corresponding to the product purchase information and accumulating and storing the corresponding product purchase information matching the item;
a periodic purchase item collecting unit determining a purchase period for each item based on the accumulated product purchase information to select one or more periodic purchase items of which purchase frequencies are equal to or more than a predetermined reference value;
a purchase pattern calculating unit calculating a purchase pattern for each periodic purchase item based on the accumulated product purchase information to correspond to the periodic purchase item; and
a periodic purchase product recommending unit selecting a recommended product based on the purchase pattern every purchase period depending on the purchase pattern for each periodic purchase item and transmitting generated recommended product information to the user apparatus.

2. The apparatus of claim 1, wherein the product purchase information is electronic receipt information.

3. The apparatus of claim 1, wherein the periodic purchase item collecting unit calculates the purchase frequency during a predetermined past period from the present.

4. The apparatus of claim 1, wherein the purchase pattern calculating unit calculates the purchase pattern including at least one of an average purchase quantity, the average number of purchase times, an average price, and a preferred manufacturer and an average purchase period for each item based on the accumulated product purchase information.

5. The apparatus of claim 4, wherein the periodic purchase product recommending unit selects the recommended product according to at least one of the average purchase quantity, the average number of purchase times, the average price, and the preferred manufacturer and transmits the recommended product information according to the average purchase period.

6. The apparatus of claim 1, wherein the periodic purchase product recommending unit transmits a link for settling the recommended product, which is included in the recommended product information together.

7. The apparatus of claim 1, wherein the settlement service providing apparatus is an online shopping mall server or a POS device.

8. The apparatus of claim 1, wherein the periodic purchase product recommending unit collects recommended product information regarding a plurality of items of which the average purchase periods coincide with each other to generate recommended list information and transmits the generated recommended list information to the user apparatus.

9. A user apparatus for recommending a product purchased periodically, the user apparatus comprising:
a purchase information collecting unit receiving product purchase information depending on product purchase of a user from an external server and accumulating and storing the received product purchase information to correspond to an item to which a product corresponding to the product purchase information belongs;
a periodic purchase item collecting unit determining a purchase period for each item based on the accumulated product purchase information to select one or more periodic purchase items of which purchase frequencies are equal to or more than a predetermined reference value;
a purchase pattern calculating unit calculating a purchase pattern for each periodic purchase item based on the accumulated product purchase information to correspond to the periodic purchase item; and
a periodic purchase product recommending unit selecting a recommended product by accessing an online shopping mall server based on the purchase pattern every purchase period depending on the purchase pattern for each periodic purchase item and providing recommended product information regarding the selected recommended product.

10. A method for providing a service for recommending a product purchased periodically, the method comprising:
collecting, by an apparatus for providing a service for recommending a product purchased periodically, which communicates with a user apparatus, product purchase information from a settlement service providing apparatus generating the product purchase information depending on product purchase of the user apparatus and accumulating and storing the collected product purchase information to correspond to an item to which a product corresponding to the product purchase information belongs;
determining, by the apparatus for providing a service for recommending a product purchased periodically, a purchase frequency for each item based on the accumulated product purchase information to select one or more periodic purchase items of which the purchase frequencies are equal to or more than a predetermined reference value;
calculating, by the apparatus for providing a service for recommending a product purchased periodically, a purchase pattern for each periodic purchase item based on the accumulated product purchase information to correspond to the periodic purchase item; and
selecting, by the apparatus for providing a service for recommending a product purchased periodically, a recommended product based on the purchase pattern every purchase period depending on the purchase pattern for each periodic purchase item and transmitting generated recommended product information to the user apparatus.
